(19) United States
(12) Patent Application Publication
(10) Pub. No.: US 2024/0031292 A1
(43) Pub. Date: Jan. 25, 2024

(54) NETWORK FLOW BASED LOAD BALANCING

(71) Applicant: VMware, Inc., Palo Alto, CA (US)

(72) Inventors: Giri Reddy, Larkspur, CA (US); Amol Manohar Vaikar, Pune (IN)

(21) Appl. No.: 18/211,557

(22) Filed: Jun. 19, 2023

(30) Foreign Application Priority Data
Jul. 25, 2022 (IN) 202241042384

(51) Int. Cl. H04L 47/125; H04L 47/62; H04L 43/062; H04L 43/045

(52) U.S. Cl. CPC H04L 47/125; H04L 47/623; H04L 43/062; H04L 43/045

(57) ABSTRACT

Some embodiments provide a method for using flow-based load balancing to select a service endpoint from multiple service endpoints in a datacenter of an enterprise network for providing one or more services to client devices in the enterprise network. The method receives, from a network modeling appliance that categorizes service endpoints based on network data, a first set of service endpoints that provide at least one particular service for which a client connection is to be scheduled. The method generates an intersecting set of service endpoints based on the received first set of service endpoints and a second set of service endpoints identified by a load balancer that performs load balancing operations for data message flows to and from the plurality of service endpoints. Based on the generated intersecting set of service endpoints, the method selects a particular service endpoint for scheduling the client connection.

### BACKGROUND

Today, load balancers are integral part of datacenters for connecting clients to servers. However, the algorithms used by these load balancers do not take into consideration the network load on links from the server to the datacenter exit point, on route to the clients. Even network-based load balancers, such as equal-cost multipath (ECMP), fail to consider the congestion in network paths when selecting server endpoints. As the modern datacenter networks employ a substantial number of commodity servers to support large scale computation, there are several paths between clients and servers. Hence, optimal utilization of the links by distributing load leads to less congestion. In addition, the incumbent nature of modern applications where the computation is performed at disaggregated server endpoints and assembled to be processed at a single node leads to collapse in throughput in-network links. Such throughput bottlenecks in links are hidden from the traditional server-based load balancers.

Additionally, the load on the network or load on the individual paths in the network are not considered in the scheduling algorithm. For example, EC1VIP employs the packet header information like source IP and destination IP and applies a hash to pick the next hop among equal-cost paths. This approach will lead to congestion in the network path leading to collisions followed by packet drops and retransmissions. Also, load balancing algorithms treat latency-sensitive connections and high-throughput connections the same. The other aspect that affects application performance is link failures that are common in network equipment leading to a disruption in traffic on assigned paths.

### BRIEF SUMMARY

Some embodiments of the invention provide a method for using flow-based load balancing to select a service endpoint from multiple service endpoints in a datacenter of an enterprise network for providing one or more services to client devices in the enterprise network. The method is performed by a load balancer that performs load balancing operations for data message flows to and from the service endpoints, in some embodiments. From a network modeling appliance that categorizes service endpoints based on network data, the method receives a first set of service endpoints (e.g., servers) that provide at least one particular service for which a client connection is to be scheduled. The method generates an intersecting set of service endpoints (e.g., by performing an intersection operation) based on the received first set of service endpoints and a second set of service endpoints identified by the load balancer (e.g., using traditional load balancing algorithms). Based on the generated intersecting set of service endpoints, the method selects a particular service endpoint for scheduling the client connection.

In some embodiments, the first set of service endpoints is received from a network modeling appliance in response to a query via an API (application programming interface) to the network modeling appliance for service endpoints associated with high throughput paths or service endpoints associated with low latency paths. The network modeling appliance of some embodiments collects network data from network devices, such as controllers, forwarding elements, and disparate servers in the datacenter, and uses the collected data to generate a network graph. In some embodiments, the collected network includes network data associated with installed network interfaces, firewall rules, forwarding rules, ARP cache entries, and interface utilization.

The network graph generated by the network modeling appliance denotes logical representations of the network including network devices and interconnecting interfaces, according to some embodiments, as well as connected paths, load of paths, and classification of paths into high throughput and low latency. In some embodiments, the first set of service endpoints are provided by the network modeling appliance to the load balancer as a set of ordered pairs, with each pair including an identifier for a service endpoint and a weight associated with the service endpoint (or links to the service endpoint). The weights, in some embodiments, are indicative of priority level such that a higher weight is associated with a higher priority. In some embodiments, the ordered pairs are ordered according to weight, and service endpoints associated with higher weights are listed first and service endpoints associated with lower weights are listed last.

In some embodiments, the second set of service endpoints are also listed in a priority order (e.g., highest priority first, lowest priority last) determined by the load balancer. Additionally, the different sets of service endpoints are classified into two classes, with the first set being a first class of service endpoints and the second set of service endpoints being a second class of service endpoints. In some embodiments, the first class of service endpoints have a higher priority than the second class of service endpoints, while in other embodiments, the second class of service endpoints have the higher priority. The load balancer of some embodiments selects the particular service endpoints by identifying one or more duplicates in the intersecting set and selecting the particular service endpoint having a highest priority from the one or more duplicates. In some embodiments, when no duplicates are identified, the load balancer instead selects a first service endpoint listed in the second set of service endpoints as the particular service endpoint for scheduling the client connection.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example of a pipeline for building a network model for use in responding to queries for path pairs in a datacenter of an enterprise network, in some embodiments.

FIG. 2 conceptually illustrates an example of a flow model of some embodiments.

FIG. 3 conceptually illustrates examples of APIs used to query the network modeling appliance, in some embodiments.

FIG. 4 conceptually illustrates a flow model of some embodiments with two paths from the load balancer to service endpoints indicated as high or low priority paths.

FIG. 5 conceptually illustrates a process performed by the load balancer in some embodiments to select a service endpoint for a client connection.

FIG. 6 conceptually illustrates a set of example scenarios of the first, second, and intersecting sets of service endpoints, and subsequently selected endpoint of some embodiments.

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for using flow-based load balancing to select a service endpoint from multiple service endpoints in a datacenter of an enterprise network for providing one or more services to client devices in the enterprise network. The method is performed by a load balancer that performs load balancing operations for data message flows to and from the service endpoints, in some embodiments. From a network modeling appliance that categorizes service endpoints based on network data, the method receives a first set of service endpoints (e.g., servers) that provide at least one particular service for which a client connection is to be scheduled. The method generates an intersecting set of service endpoints (e.g., by performing an intersection operation) based on the received first set of service endpoints and a second set of service endpoints identified by the load balancer (e.g., using traditional load balancing algorithms). Based on the generated intersecting set of service endpoints, the method selects a particular service endpoint for scheduling the client connection.

In some embodiments, the first set of service endpoints is received from a network modeling appliance in response to a query via an API to the network modeling appliance for service endpoints associated with high throughput paths or service endpoints associated with low latency paths. The network modeling appliance of some embodiments collects network data from network devices, such as controllers, forwarding elements, and disparate servers in the datacenter, and uses the collected data to generate a network graph. In some embodiments, the collected network includes network data associated with installed network interfaces, firewall rules, forwarding rules, ARP cache entries, and interface utilization.

The network graph generated by the network modeling appliance denotes logical representations of the network including network devices and interconnecting interfaces, according to some embodiments, as well as connected paths, load of paths, and classification of paths into high throughput and low latency. In some embodiments, the first set of service endpoints are provided by the network modeling appliance to the load balancer as a set of ordered pairs, with each pair including an identifier for a service endpoint and a weight associated with the service endpoint (or links to the service endpoint). The weights, in some embodiments, are indicative of priority level such that a higher weight is associated with a higher priority. In some embodiments, the ordered pairs are ordered according to weight, and service endpoints associated with higher weights are listed first and service endpoints associated with lower weights are listed last.

In some embodiments, the second set of service endpoints are also listed in a priority order (e.g., highest priority first, lowest priority last) determined by the load balancer. Additionally, the different sets of service endpoints are classified into two classes, with the first set being a first class of service endpoints and the second set of service endpoints being a second class of service endpoints. In some embodiments, the first class of service endpoints have a higher priority than the second class of service endpoints, while in other embodiments, the second class of service endpoints have the higher priority. The load balancer of some embodiments selects the particular service endpoints by identifying one or more duplicates in the intersecting set and selecting the particular service endpoint having a highest priority from the one or more duplicates. In some embodiments, when no duplicates are identified, the load balancer instead selects a first service endpoint listed in the second set of service endpoints as the particular service endpoint for scheduling the client connection.

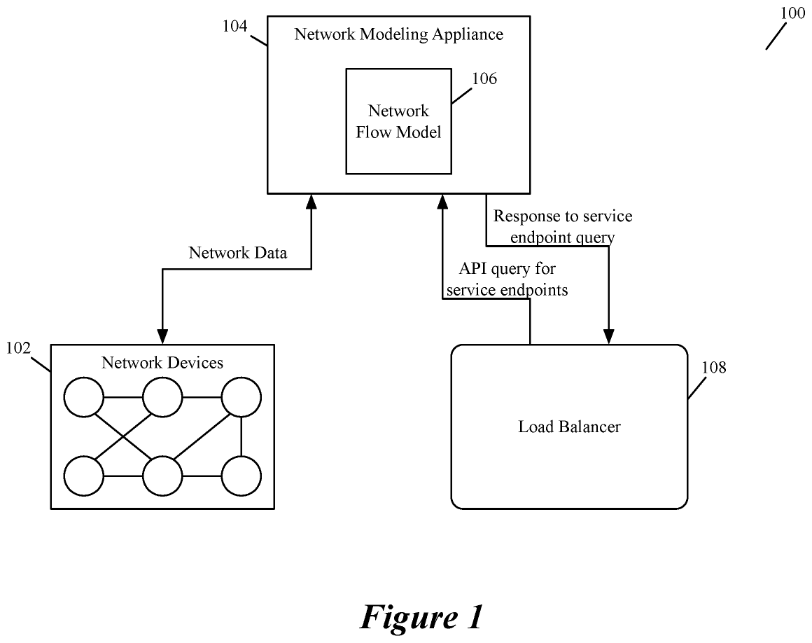

FIG. 1 illustrates an example of a pipeline 100 for building a network model for use in responding to queries for path pairs in a datacenter of an enterprise network, in some embodiments. As shown, the pipeline 100 includes network devices 102, a network modeling appliance 104 that includes a network flow model 106, and a load balancer 108. The network devices 102, in some embodiments, include controllers (e.g., network controllers), disparate servers (e.g., servers that provide one or more services for end-user devices), and forwarding elements (e.g., switches, routers, etc.). The disparate servers, in some embodiments, include service endpoints to which the load balancer 108 schedules client connections.

To construct a network link load aware load balancer, the network modeling appliance 104 of some embodiments collects network data from the network devices 102 and uses the collected network data to construct a network map and generate the network flow model 106. The collected network data of some embodiments includes data associated with installed network interfaces, firewall rules, forwarding rules, ARP (address resolution protocol) cache entries, and interface utilization. In some embodiments, the network modeling appliance 104 is a network modeling controller that includes a designated data collection engine for collecting network data from the network devices 102. The network modeling appliance 104 of some embodiments collects network path information using an algorithm described in “Network-Wide Verification of Invariants” (U.S. Pat. No. 9,225,601), which is incorporated herein by reference. The “network-wide invariant” algorithm of some embodiments enables the network modeling appliance 104 to connect to all the network devices 102 in the datacenter to collect the network data as mentioned above.

In some embodiments, the network map generated by the network modeling appliance 104 spans one or more paths from the load balancer to one or more servers, including the network forwarding elements (e.g., switches and routers) and links between the network forwarding elements and one or more servers. The links included in the network map of some embodiments include both North-South links and East-West links. The network modeling appliance 104 in some embodiments uses the network map to construct the network flow model 106. In some embodiments, the network flow model 106 denotes a logical representation of the network that includes the network devices and interconnecting interfaces. In addition to the logical representations, the network flow model 106 in some embodiments also includes the load of the paths between the client devices and classification of the paths into a high throughput class and a low latency class.

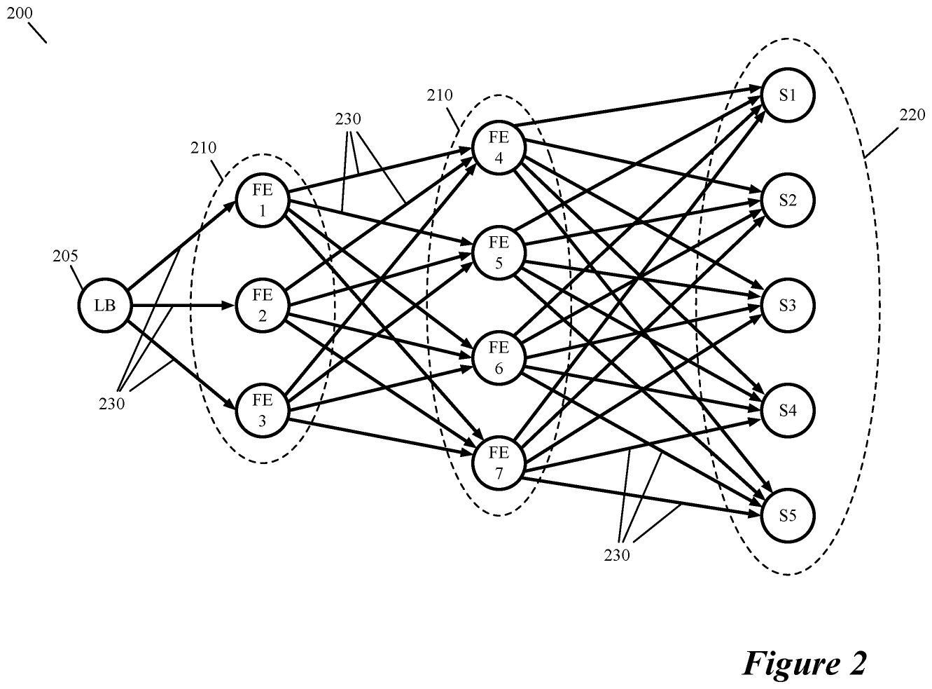

FIG. 2 conceptually illustrates an example of a flow model of some embodiments. As shown, the flow model 200 includes a node representing a load balancer 205, multiple nodes representing forwarding elements 210, nodes representing service endpoints 220, and the connections between the nodes 230. In addition to receiving a classification of “high throughput” or “low latency”, each path between the load balancer node 205 and the service endpoint nodes 220 is assigned an associated weight that represents a priority level of the path, in some embodiments, by the network modeling appliance 104.

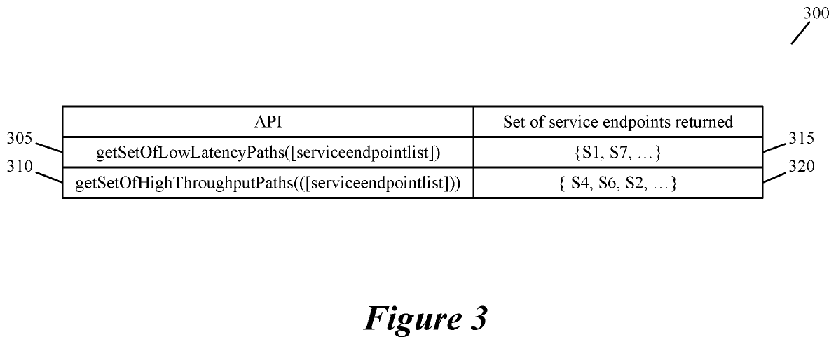

In some embodiments, the servers hosting the services are deemed as service endpoints and also categorized into classes based on the path classifications (i.e., high-throughput or low latency). Examples of service endpoints in some embodiments include video/audio service endpoints and transaction-oriented service endpoints. The load balancer 108 schedules client connections to service endpoints by first querying via API the network modeling appliance 104 for service endpoints that can provide a service desired by a particular client. For example, FIG. 3 conceptually illustrates examples of APIs used to query the network modeling appliance 104, in some embodiments.

As shown, the set of APIs 300 include a first API 305 for querying the network modeling appliance 104 for service endpoints associated with low latency paths (getSetOfLowLatencyPaths([serviceendpointlist])) and a second API 310 for querying the network modeling appliance 104 for service endpoints associated with high throughput paths (getSetOfHighThroughputPaths([serviceendpointlist])). As indicated by the sets of service endpoints returned 315 and 320, the service endpoints of some embodiments are designated as S1, S2, S3, etc.

The network modeling appliance 104 of some embodiments uses the generated network flow model 106 to identify the set of service endpoints to provide to the load balancer 108 in response to the query. In some embodiments, the network modeling appliance 104 also assigns weights representing priority levels of the links for each service endpoint, as mentioned above, with higher weights corresponding to higher priority links. In some embodiments, the set of service endpoints provided by the network modeling appliance 104 in response to the query are provided as a set of tuple pairs, where each tuple is of the form <service endpoint, weight>.

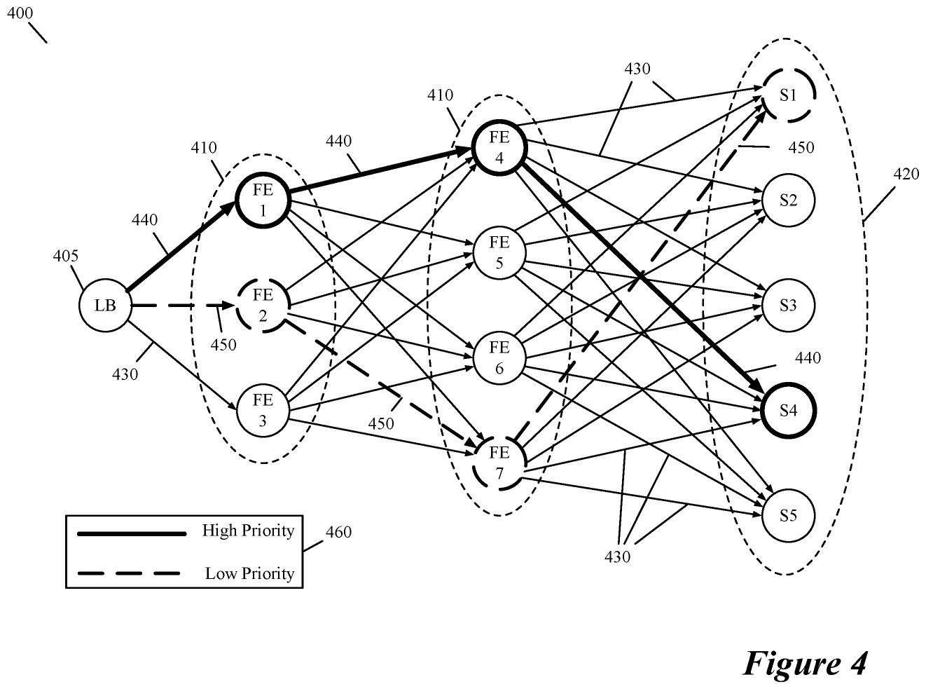

FIG. 4 conceptually illustrates a flow model of some embodiments with two paths from the load balancer to service endpoints indicated as high or low priority paths. Like the flow model 200, the flow model 400 includes a node representing a load balancer 405, multiple nodes representing forwarding elements 410, nodes representing service endpoints 420, and the connections between the nodes 430. In addition, the flow model 400 emphasizes two paths 440 and 450 from the load balancer node 405 to a service endpoint 420 ‘S4’ and a service endpoint 420 ‘51’, respectively. In some embodiments, the paths 440 and 450 are the best path options for reaching the service endpoints ‘S4’ and ‘S1’, respectively. As indicated by the legend 460, the path 440 is a high priority path, while the path 450 is a low priority path. Accordingly, the path 440 would be assigned a higher weight than the path 450.

In addition to providing the set of service endpoints as a set of tuple pairs, the network modeling appliance 104 of some embodiments returns the set as ordered pairs, where the order is determined by weight (i.e., higher weight should be on top of list in each returned set). For example, in some embodiments, if the original service endpoint list is {Si, S2, S3, S4, S5, S6, 57} and the API getSetOfLowLatencyPaths( )returns {<52, 88>, <S5, 62>, <S6, 30>}, this implies that the network modeling 104 did not identify any low latency paths to {Si, S3, S4, 57} of the original service endpoint list. In some embodiments, this returned set of service endpoints is

H811 8 referred to as a network modeler set. Based on the flow model 400, a network modeler set that includes service endpoints ‘S1’ and ‘S4’ would list the service endpoint ‘S4’ before ‘S1’ due to the higher priority, and thus higher weight, associated with the path 440 to ‘S4’.

In addition to the network modeler set received from the network modeling appliance 104, the load balancer 108 of some embodiments also identifies a set of service endpoints using its own algorithm or algorithms. These algorithms, in some embodiments, include traditional load balancer algorithms, such as round-robin (i.e., client connections get to a rotating list of servers), least connection (i.e., client connections get forwarded to servers with least connections), least response time (client connections get forwarded to servers based on the time servers take to respond to health monitoring requests), least bandwidth method (client connections get forwarded to servers with least amount of traffic measured in Mbps), hashing method (client connections get forwarded to servers based on hash computed from packet header information i.e., SrcIP, DestlP, SrcPort, DestPort), and server load methods (client connection get forwarded to servers based on individual load factor on the servers, and the load is computed using CPU usage or memory on the servers).

In some embodiments, algorithms used to generate the service endpoint sets are organized into classes. The class one set holds the algorithm that produces the network modeler set of service endpoints and the class two set holds the algorithm(s) that produces the load balancer set of service endpoints, according to some embodiments. In some embodiments, the service endpoints in the class one set have higher priority than the service endpoints in class two set, while in other embodiments, the service endpoints in the class two set have a higher priority than the service endpoints in the class one set.

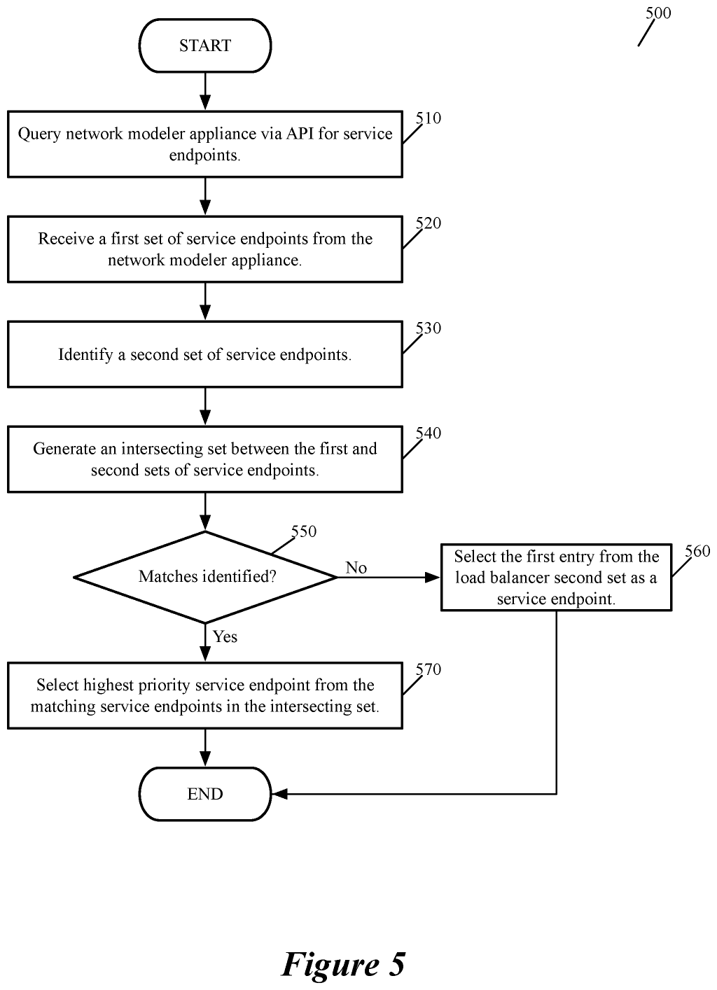

In some embodiments, the load balancer 108 uses the set of service endpoints from the network modeling appliance 104 and its own set of service endpoints (e.g., a set of service endpoints identified using one of the traditional load balancing algorithms mentioned above to select a service endpoint to which to schedule a client connection. FIG. 5 conceptually illustrates a process performed by the load balancer in some embodiments to select a service endpoint for a client connection. The process 500 starts when the load balancer queries (at 510) the network modeler appliance via an API for service endpoints. As described above, the load balancer uses one of the APIs 305 or 310 to query the network modeling appliance 104.

The process 500 receives (at 520) a first set of service endpoints from the network modeler appliance. For example, the load balancer of some embodiments receives a set of ordered pairs from the network modeling appliance, with each pair indicating an identifier for the service endpoint (e.g., “S1”) and a corresponding weight associated with the service endpoint and representing a priority level of the service endpoint. The set of ordered pairs are provided in order of priority level, with the highest priority service endpoint being at the top of the list (i.e., listed first in the set) and the lowest priority service endpoint being at the bottom of the list (i.e., listed last in the set).

The process identifies (at 530) a second set of service endpoints. This second set of service endpoints, in some embodiments, is the set of service endpoints identified by the load balancer using the traditional load balancer algorithms, such as round robin, least connection, least response time, least bandwidth method, hashing method, and server load methods. Like the set of service endpoints provided by the network modeling appliance, the set of service endpoints identified by the load balancer are also ordered according to priority level, with the highest priority service endpoint being listed first and the lowest priority service endpoint being listed last.

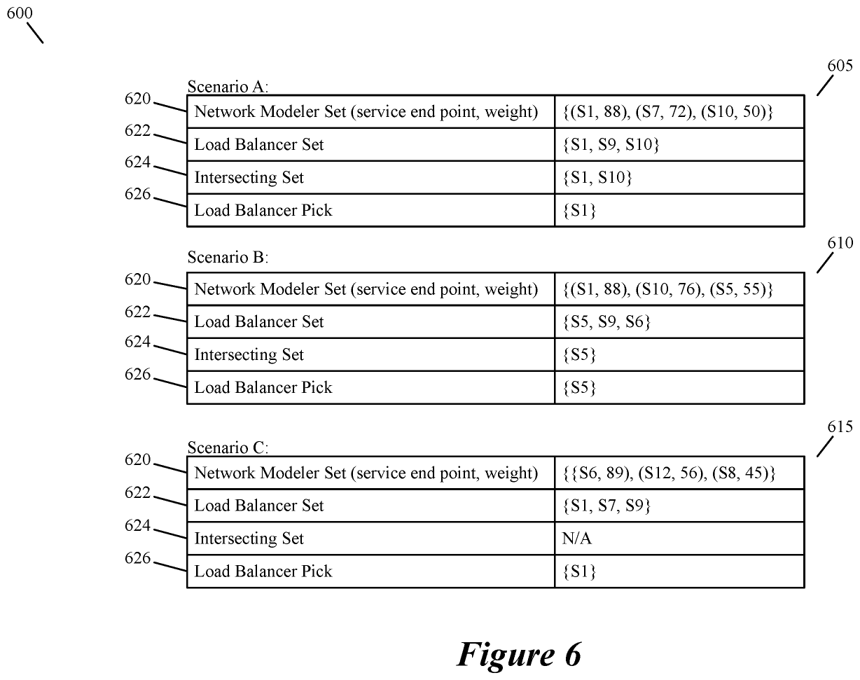

The process 500 generates (at 540) an intersecting set of service endpoints between the first and second sets of service endpoints. In some embodiments, the process performs an intersection operation to generate the intersecting set. FIG. 6 conceptually illustrates a set of example scenarios 600 of the first, second, and intersecting sets of service endpoints, and subsequently selected endpoint of some embodiments. As show, each scenario 605, 610, and 615 in the set 600 includes a respective network modeler set 620, load balancer set 622, intersecting set 624, and load balancer pick 626. For each of the network modeler, load balancer, and intersecting sets, the service endpoints are organized by priority level, with the first service endpoint in each set having the highest priority.

In this example, scenario A 605 is the best case scenario based on the network modeler and load balancer sets having picked the same service endpoint (S1) as the first listed endpoint (i.e., highest priority). Scenario B 610 illustrates the average scenario in which the network modeler' s topmost pick is not part of the load balancers set. Scenario C 615 is the worst scenario in this example as none of the service endpoints in the load balancer set match with service endpoints in the network modeler set. As a result, scenario C 615 does not have an intersecting set.

The process 500 then determines (at 550) whether any matches are identified in the intersecting set. That is, the process determines whether there are any service endpoints in the intersecting set. For instance, in the set of scenarios 600, scenario A 605 includes two service endpoints in its intersecting set, scenario B 610 includes one service endpoint in its intersecting set, and scenario C 615 does not have an intersecting set as there are no matches between the service endpoints of its network modeler and load balancer sets. When there are no matches, such as in the scenario C 615, the process 500 transitions to select (at 560) the first entry from the load balancer set of service endpoints as the service endpoint for the client connection. For instance, the load balancer pick 626 for the scenario C 615 is the service endpoint Si because Si is the first entry in the load balancer set 622 for this scenario. In other embodiments, the first entry from the network modeler set may instead be selected.

When the process 500 determines that there are matches, the process transitions to select (at 570) the highest priority service endpoint from the matching service endpoints in the intersecting set. For scenario A 605, the load balancer pick 626 is identified as ‘S1’ because ‘S1’ is a higher priority service endpoint than ‘S10’ in the intersecting set 624 for scenario A 605. Scenario B 610 only has one service endpoint, ‘S5’, in its respective intersecting set 624, and as such, the load balancer pick 626 for scenario B 610 is ‘S5’, as illustrated. In essence, the network modeler set in some embodiments determines the priority of service endpoints that are picked over what the traditional load balancer scheduler would pick. The intersection operation allows the algorithm to pick the best network path in conjunction with the load heuristics of the server load. Following 570, the process 500 ends.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

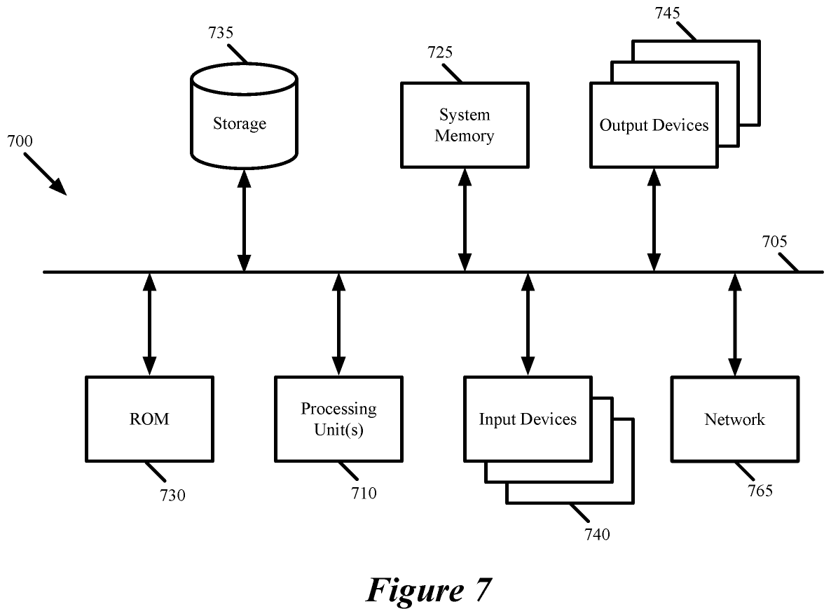

FIG. 7 conceptually illustrates a computer system 700 with which some embodiments of the invention are implemented. The computer system 700 can be used to implement any of the above-described hosts, controllers, gateway, and edge forwarding elements. As such, it can be used to execute any of the above described processes. This computer system 700 includes various types of non-transitory machine-readable media and interfaces for various other types of machine-readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) 710 may be a single processor or a multi-core processor in different embodiments. The read-only-memory (ROM) 730 stores static data and instructions that are needed by the processing unit(s) 710 and other modules of the computer system 700. The permanent storage device 735, on the other hand, is a read-and-write memory device. This device 735 is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device. Like the permanent storage device 735, the system memory 725 is a read-and-write memory device. However, unlike storage device 735, the system memory 725 is a volatile read-and-write memory, such as random access memory. The system memory 725 stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the computer system 700. The input devices 740 include alphanumeric keyboards and pointing devices (also called “cursor control devices”). The output devices 745 display images generated by the computer system 700. The output devices 745 include printers and display devices, such as cathode ray tubes (CRT) or liquid crystal displays (LCD). Some embodiments include devices such as touchscreens that function as both input and output devices 740 and 745.

Finally, as shown in FIG. 7, bus 705 also couples computer system 700 to a network 765 through a network adapter (not shown). In this manner, the computer 700 can be a part of a network of computers (such as a local area network (“LAN”), a wide area network (“WAN”), or an Intranet), or a network of networks (such as the Internet). Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for using flow-based load balancing to select a service endpoint from a plurality of service endpoints in a datacenter of an enterprise network for providing one or more services to client devices in the enterprise network, the method comprising:
receiving, from a network modeling appliance that categorizes service endpoints based on network data, a first set of service endpoints that provide at least one particular service for which a client connection is to be scheduled;
generating an intersecting set of service endpoints based on the received first set of service endpoints and a second set of service endpoints identified by a load balancer that performs load balancing operations for data message flows to and from the plurality of service endpoints; and
based on the generated intersecting set of service endpoints, selecting a particular service endpoint for scheduling the client connection.

2. The method of claim 1, wherein the first set of service endpoints provided by the network modeling appliance comprise one or more service endpoints that the network modeling appliance has identified as being accessible through a high throughput or low latency path.

3. The method of claim 1, wherein receiving the first set of service endpoints from the network modeling appliance comprises:
sending a query to a network modeling appliance to request one or more service endpoints that provide a particular service; and
in response to the query, receiving the first set of service endpoints from the network modeling appliance.

4. The method of claim 3, wherein the query comprises an API (application programming interface) for service endpoints associated with one of high throughput paths and low latency paths.

5. The method of claim 4, wherein the network modeling appliance categorizes service endpoints based on network data by (i) collecting network data from a plurality of network devices in the enterprise network and (ii) using the collected network data to generate a network graph that denotes logical representations of the network devices and connections between the network devices as one of high throughput and low latency.

6. The method of claim 5, wherein the network devices comprise controllers and disparate servers in the datacenter.

7. The method of claim 5, wherein the network data comprises network data associated with installed network interfaces, firewall rules, forwarding rules, ARP (address resolution protocol) cache entries, and interface utilization.

8. The method of claim 1, wherein the first set of service endpoints comprises a set of ordered pairs, each ordered pair comprising (i) an identifier for a respective service endpoint and (ii) a weight value associated with the respective service endpoint.

9. The method of claim 8, wherein:
higher weight values are associated with higher priority; and
the first set of service endpoints are ordered according to weight such that service endpoints associated with higher weights are listed first and service endpoints associated with lower weights are listed last.

10. The method of claim 1, wherein generating the intersecting set of service endpoints based on the received first set of service endpoints and the identified second set of service endpoints comprises performing an intersection operation on the first and second sets of service endpoints.

11. The method of claim 10, wherein service endpoints in each of the first, second and intersecting sets of service endpoints are organized by priority levels assigned to each service endpoints, wherein (i) service endpoints assigned higher priority levels are listed first in the each of the first, second and intersecting sets of service endpoints, and (ii) service endpoints assigned lower priority levels are listed last in the each of the first, second and intersecting sets of service endpoints.

12. The method of claim 11, wherein selecting the particular service endpoint for scheduling the client connection based on the generating intersecting set of service endpoints comprises:
identifying one or more duplicates in the intersecting set of service endpoints; and
selecting, from the identified one or more duplicates, a service endpoint having a highest priority.

13. The method of claim 12, wherein when the intersecting set of service endpoints does not include any duplicates, the method further comprises selecting a highest priority service endpoint from the second set of service endpoints.

14. A non-transitory machine readable medium storing a program which when executed by at least one processing unit uses flow-based load balancing to select a service endpoint from a plurality of service endpoints in a datacenter of an enterprise network for providing one or more services to client devices in the enterprise network, the program comprising sets of instructions for:
receiving, from a network modeling appliance that categorizes service endpoints based on network data, a first set of service endpoints that provide at least one particular service for which a client connection is to be scheduled;
generating an intersecting set of service endpoints based on the received first set of service endpoints and a second set of service endpoints identified by a load balancer that performs load balancing operations for data message flows to and from the plurality of service endpoints; and
based on the generated intersecting set of service endpoints, selecting a particular service endpoint for scheduling the client connection.

15. The non-transitory machine readable medium of claim 14, wherein the set of instructions for receiving the first set of service endpoints from the network modeling appliance comprises sets of instructions for:
sending a query to a network modeling appliance to request one or more service endpoints that provide a particular service; and
in response to the query, receiving the first set of service endpoints from the network modeling appliance.

16. The non-transitory machine readable medium of claim 15, wherein the query comprises an API (application programming interface) for service endpoints associated with one of high throughput paths and low latency paths.

17. The non-transitory machine readable medium of claim 16, wherein the network modeling appliance categorizes service endpoints based on network data by (i) collecting network data from a plurality of network devices in the enterprise network and (ii) using the collected network data to generate a network graph that denotes logical representations of the network devices and connections between the network devices as one of high throughput and low latency.

18. The non-transitory machine readable medium of claim 17, wherein the network devices comprise controllers and disparate servers in the datacenter.

19. The non-transitory machine readable medium of claim 17, wherein the network data comprises network data associated with installed network interfaces, firewall rules, forwarding rules, ARP (address resolution protocol) cache entries, and interface utilization.

20. The non-transitory machine readable medium of claim 14, wherein:
the first set of service endpoints comprises a set of ordered pairs, each ordered pair comprising (i) an identifier for a respective service endpoint and (ii) a weight value associated with the respective service endpoint;
higher weight values are associated with higher priority; and
the first set of service endpoints are ordered according to weight such that service endpoints associated with higher weights are listed first and service endpoints associated with lower weights are listed last.
